(19) United States
(12) Patent Application Publication
(10) Pub. No.: US 2024/0161170 A1
(43) Pub. Date: May 16, 2024

(54) INFORMATION PROCESSING APPARATUS

(71) Applicant: TOYOTA JIDOSHA KABUSHIKI KAISHA, Toyota-shi (JP)

(72) Inventors: Kenji YAMAGUCHI, Miyoshi-shi (JP); Yohei NAKANISHI, Nagoya-shi (JP); Yu HAMADA, Nagoya-shi (JP)

(73) Assignee: TOYOTA JIDOSHA KABUSHIKI KAISHA, Toyota-shi (JP)

(21) Appl. No.: 18/504,346

(22) Filed: Nov. 8, 2023

(30) Foreign Application Priority Data
Nov. 10, 2022 (JP) 2022-180589

(51) Int. Cl. G06Q 30/0601

(52) U.S. Cl. CPC G06Q 30/0631

(57) ABSTRACT

An information processing apparatus for determining a specification of a vehicle ordered by a user, comprises a controller unit configured to execute: receiving designation of a body color of the vehicle from the user; and proposing to the user to overcoat the vehicle with a second body color by an easily peelable paint after ordering the vehicle having any of a plurality of first body colors when the second body color that is not included in the plurality of first body colors set as a base color of the vehicle is designated by the user.

### CROSS REFERENCE TO THE RELATED APPLICATION

This application claims the benefit of Japanese Patent Application No. 2022-180589, filed on Nov. 10, 2022, which is hereby incorporated by reference herein in its entirety.

### BACKGROUND

### Technical Field

The present disclosure relates to an information processing apparatus.

### Description of the Related Art

A technique for changing the color of a car body by overcoating the car body of a car body with a peelable paint film is known. See, for example, Japanese Patent Laid-Open No. 2022-059901.

### SUMMARY

It is an object of the present disclosure to provide a vehicle having a body color desired by a user.

A first aspect of the present disclosure is an information processing apparatus for determining a specification of a vehicle ordered by a user, comprising a controller unit configured to execute: receiving designation of a body color of the vehicle from the user; and proposing to the user to overcoat the vehicle with a second body color by an easily peelable paint after ordering the vehicle having any of a plurality of first body colors when the second body color that is not included in the plurality of first body colors set as a base color of the vehicle is designated by the user.

Further, another aspect of the present disclosure is a method executed by the information processing apparatus, a program for causing a computer to execute the method, or a computer-readable storage medium in which the program is non-transitory stored.

### BRIEF DESCRIPTION OF THE DRAWINGS

FIG. 1 is a diagram showing an outline of a vehicle order system.

FIG. 2 is a diagram illustrating a configuration of a contract server and a user terminal.

FIG. 3A to 3C are examples of specification data, basic color data, and top coat color data.

FIG. 4A to 4B are outline views of painting with an easily peelable paint.

FIG. 5 is a flowchart of a process executed by a contract server.

FIG. 6A to 6C are examples of a screen for designating a body color of a vehicle.

FIG. 7 is a flowchart of a process executed in step S16.

### DESCRIPTION OF THE EMBODIMENTS

A technique for painting a vehicle using a peelable paint is known. The peelable paint is a paint that forms a paint film that can be easily peeled off from the vehicle body by applying a force from the outside.

For example, any vehicle can be changed to a user's preferred color by overcoating the vehicle having a peelable body color with a peelable paint. As a result, for example, when ordering a vehicle, it is possible to select a body color that is popular in the market and then overcoat the user's favorite color. Vehicles painted with peelable paint can regain their body color by peeling off the paint film, so by using the popular color as the base color, it is possible to maintain high value when reselling used cars.

In such a case, when ordering a vehicle, it must be decided whether or not to use a peelable paint. The information processing apparatus according to the present disclosure determines whether or not suggest to use a peelable paint based on the body color of the vehicle desired by the user.

The information processing apparatus according to the first aspect of the present disclosure is an information processing apparatus for determining a specification of a vehicle ordered by a user, comprising a controller unit configured to execute: receiving designation of a body color of the vehicle from the user; and proposing to the user to overcoat the vehicle with a second body color by an easily peelable paint after ordering the vehicle having any of a plurality of first body colors when the second body color that is not included in the plurality of first body colors set as a base color of the vehicle is designated by the user.

The easily peelable paint is a paint that forms a peelable coating film. The easily peelable paint may be a peelable layer of the paint itself, or may consist of a peelable layer and a layer of paint formed on the peelable layer. By painting the vehicle with an easily peelable paint and peeling off the paint afterwards, the body color of the vehicle can be changed.

When a user orders a vehicle, in addition to ordering a vehicle having a specified body color, a method of applying an easily peelable paint to a vehicle having an arbitrary body color can be taken. This makes it possible to provide the user with a vehicle having a body color that is not set as the base color. In addition, by making the body color with high resale value the first body color, it is possible to improve the value when reselling used cars.

The information processing apparatus according to the present disclosure suggests to the user whether or not to overcoat using an easily peelable paint based on the specified body color. For example, if the body color desired by the user is present in the color lineup of the corresponding vehicle, it is not necessary to overcoat using an easily peelable paint. On the other hand, if the body color desired by the user is not present in the color lineup of the corresponding vehicle, it can be suggested to overcoat using an easily peelable paint. By using an easily peelable paint, it is possible to achieve a body color that is not in the conventional color lineup.

The controller unit may present a list of the plurality of first body colors and the plurality of second body colors that are colors that can be overcoated with the easily peelable paint. The controller unit can determine which method to suggest to the user based on the body color selected from the list. For example, when the selected color is included in the first body color, the controller unit suggests to order a vehicle having a designated body color. Further, when the selected color is not included in the first body color and is included in the second body color, the controller unit suggests to overcoat the vehicle having an arbitrary body color with an easily peelable paint.

Further, the controller unit may selectively present a list of the plurality of first body colors and a list of the plurality of second body colors that are colors that can be overcoated with the easily peelable paint. For example, when the user desires a body color that is not set as the base color, the selection may be accepted after presenting a list of body colors (second body colors) that can be overcoated.

When presenting the plurality of second body colors, the controller unit may omit the presentation of body colors in which the degree of similarity with any of the plurality of first body colors is equal to or greater than a predetermined value. Further, the controller unit may propose to the user not to use the easily peelable paint when a body color that is a body color included in the plurality of second body colors and whose degree of similarity with any of the plurality of first body colors is a predetermined value or more is specified.

The second body color has more color variations than the first body color, and may include colors similar to the first body color. Therefore, a body color whose degree of similarity with the first body color is equal to or greater than a predetermined value can be omitted from the list of the second body colors. Alternatively, if the body color is selected, it may notify that a similar body color is present in the list of base colors.

Specific embodiments of the present disclosure will be described below on the basis of the drawings. The hardware configuration, module configuration, function configuration, and the like described in each embodiment are not intended to limit the technical scope of disclosure to those only unless otherwise described.

### First Embodiment

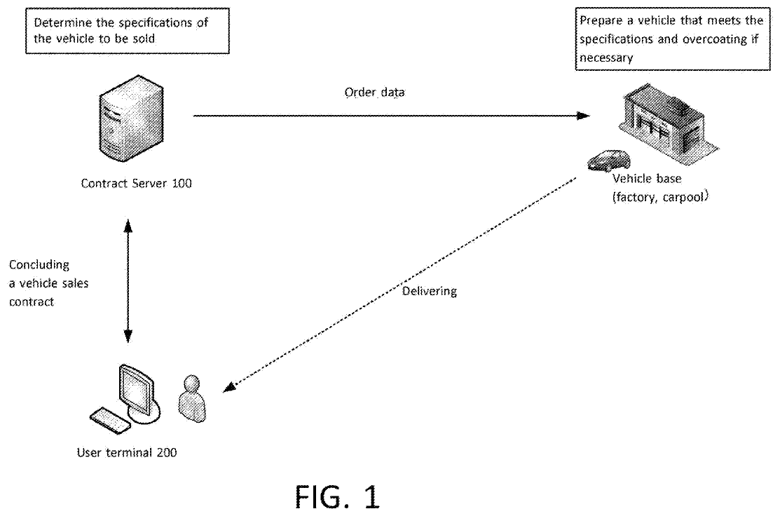

An outline of the vehicle ordering system according to the first embodiment will be described with reference to FIG. 1. The vehicle ordering system according to the present embodiment includes a contract server 100 and a user terminal 200.

The contract server 100 is a server device for concluding a sales contract for a vehicle with a user. By interacting with the user terminal 200, the contract server 100 determines the specifications of the vehicle to be sold to the user and concludes a sales contract.

The user terminal 200 is a computer used by a user who purchases a vehicle. The user can access the contract server 100 via the user terminal 200 and apply for a contract to sell or buy a vehicle. Here, it is assumed that the sales contract is concluded online, but the sales contract may be concluded at a store (for example, a car dealer). In this case, the user terminal 200 may be a computer installed in the store.

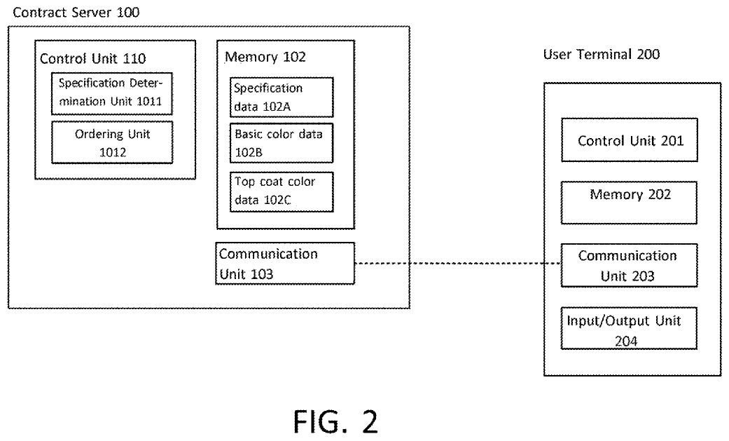

FIG. 2 is a diagram showing in more detail the components of the contract server 100 and the user terminal 200 included in the vehicle ordering system according to the present embodiment. Here, the user terminal 200 will be described first. The user terminal 200 is a computer used by an individual, such as a personal computer, a smartphone, a mobile phone, a tablet computer, or a personal information terminal. The user terminal 200 includes a controller unit 201, a storage 202, a communication unit 203, and an input/output unit 204.

The controller unit 201 is an arithmetic device that controls the user terminal 200. The controller unit 201 can be realized by an arithmetic processing device such as a central processing unit (CPU). The controller unit 201 executes a function of performing an interaction by accessing the contract server 100. The function may be realized by a web browser operating on the user terminal 200 or a dedicated application software.

The storage 202 includes a main memory and an auxiliary storage device. The main memory is a memory in which a program executed by the controller unit 201 and data used by the control program are expanded. The auxiliary storage device is a device in which a program executed by the controller unit 201 and data used by the control program are stored. The auxiliary storage device may store a package of programs executed by the controller unit 201 as an application. The auxiliary storage device may also store an operating system for executing these applications. When the program stored in the auxiliary storage device is loaded into the main memory and executed by the controller unit 201, the process described below is performed.

The main memory may include a random access memory (RAM) or a read-only memory (ROM). Further, the auxiliary storage device may include an EPROM (Erasable Programmable ROM) or a hard disk drive (HDD, Hard Disk Drive). Further, the auxiliary storage device may include removable media, i.e., portable recording media.

The communication unit 203 is a wireless communication interface for connecting the user terminal 200 to a network. The communication unit 203 is configured to be able to communicate with the contract server 100 via, for example, a mobile communication service such as a wireless LAN or 3G, 4G, or 5G. The input/output unit 204 is a unit that receives input operations performed by a user and presents information to the user. In the present embodiment, the input/output unit 204 includes one touch panel display. That is, the input/output unit 204 is composed of a liquid crystal display, a controller unit for the liquid crystal display, and a controller unit for the touch panel and the touch panel.

Next, the contract server 100 will be described. The contract server 100 is a server device that concludes a sales contract for a vehicle based on the result of the interaction performed with the user terminal 200.

In the present embodiment, the contract server 100 may be configured to be able to execute a web server for performing an interaction with the user terminal 200. In this case, for example, the user terminal 200 can perform a procedure for concluding a contract by accessing the Web service using a browser. The contract server 100 may provide the service by means other than the Web server. For example, the contract server 100 may execute a service that interacts with the dedicated application software installed in the user terminal 200 by a predetermined protocol.

The contract server 100 can be configured as a computer having a processor such as a CPU or GPU, a main memory such as a RAM or ROM, an auxiliary storage device such as an EPROM, a hard disk drive, and a removable medium. An operating system (OS), various programs, various tables, and the like are stored in the auxiliary storage device, a program stored therein is loaded into a work area of the main memory and executed, and each component part and the like is controlled through execution of the program, and each function that matches a predetermined purpose described later can be realized in the auxiliary storage device. However, some or all functions may be realized by hardware circuits such as ASICs and FPGAs.

The contract server 100 includes a controller unit 101, a storage 102, and a communication unit 103. The controller unit 101 is an arithmetic device that controls the contract server 100. The controller unit 101 can be realized by an arithmetic processing device such as a CPU. The controller unit 101 includes two functional modules, a specification determination unit 1011 and an ordering unit 1012. Each functional module may be realized by executing the stored program by the CPU.

The specification determination unit 1011 determines the specifications of the vehicle related to the purchase and sale by performing an interaction with the user terminal 200. The specification determination unit 1011 determines the following matters as the specifications of the vehicle. In the following description, the vehicle sold to the user is simply referred to as a “vehicle”. In addition, sales include sales based on residual value-setting credits, lease sales, and other sales on the premise that the vehicle is returned or sold after a predetermined period has elapsed.
(1) Model and grade
(2) Body color
(3) Others (option, etc.)

Here, the body color is the color of the vehicle body desired by the user. Body color does not necessarily have to be a single color. The body color may be a two-tone color or an accent color. In the following description, the original body color of the vehicle is referred to as the first body color. Further, the color of the body desired by the user is referred to as the desired body color, and the body color overcoated with an easily peelable paint is referred to as the second body color.

When the body color desired by the user is a color set as the base color of the target vehicle, the vehicle in which the first body color is the desired body color may be ordered (option 1). On the other hand, when the body color desired by the user is not the color set as the base color of the target vehicle, after ordering a vehicle having an arbitrary first body color, the desired body color with an easily peelable paint is applied to the vehicle. (Option 2). In this case, by setting the first body color to a body color having a high resale value, it is possible to give a monetary advantage to the user.

The contract server 100 according to the present embodiment determines which method to take, option 1 or option 2, based on the base color set for the target vehicle and the body color desired by the user, and suggests the determined method to the user. When option 2 is adopted, a vehicle with a body color that is not set for the target vehicle can be provided to the user.

Based on the specifications determined by the specification determination unit 1011, the ordering unit 1012 generates data for instructing the ordering of the vehicle (order instruction data) and transmits the data to the appropriate vehicle base. When the vehicle is an inventory vehicle, the vehicle base can be a car pool to which the vehicle belongs. Further, when the vehicle is made-to-order, the vehicle base can be a vehicle manufacturing factory. In addition, when the specification determination unit 1011 determines the use of the easily peelable paint, the ordering unit 1012 causes the ordering instruction data to include a painting instruction for the vehicle using the easily peelable paint. For example, when a desired body color (for example, red) different from the first body color (for example, white color) is specified, the ordering unit 1012 includes an instruction to “overcoat and ship a vehicle having a white body color in red” in the ordering instruction data.

The storage 102 includes a main memory and an auxiliary storage device. The main memory is a memory in which a program executed by the controller unit 101 and data used by the control program are expanded. The auxiliary storage device is a device in which a program executed by the controller unit 101 and data used by the control program are stored.

Further, the storage 102 stores the specification data 102A, the basic color data 102B, and the top coat color data 102C.

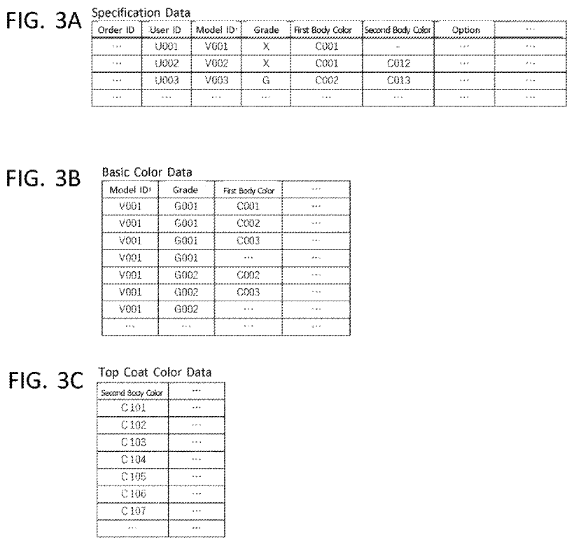

The specification data 102A is data including specifications of the vehicle to be ordered, and is generated by the ordering unit 1012. FIG. 3A is an example of specification data 102A. As illustrated, the specification data 102A has the following fields: order ID, user ID, model ID, grade, first body color, second body color, and option. The order ID field stores a unique identifier for each order of the vehicle. In the user ID field, an identifier that uniquely identifies a user who orders a vehicle is stored. The model ID field stores an identifier that uniquely identifies the vehicle model. The grade field stores an identifier that uniquely identifies the grade of the vehicle. In the first body color field, an identifier of the original body color possessed by the target vehicle is stored. In the second body color field, the identifier of the body color to be overcoated by the easily peelable paint is stored. If the easily peelable paint is not used, the value is not stored in the second body color field. In the option field, information related to other specifications (for example, options, etc.) is stored.

The basic color data 102B is data that defines a base color (first body color) set for each vehicle model.

FIG. 3B is an example of the basic color data 102B. As illustrated, the basic color data 102B includes each field of the model ID, grade, and first body color. The model ID field stores an identifier that uniquely identifies the vehicle model. The grade field stores an identifier that uniquely identifies the grade of the vehicle. In the first body color field, an identifier of the first body color set as the base color in the target vehicle model is stored. For example, in the illustrated example, the model having the identifier V001 and the grade having the identifier G001 has three base colors C001, C002, and C003. The basic color data 102B may include color sample data for each body color and image data corresponding to the appearance.

Further, the storage 202 stores the top coat color data 102C. The top coat color data 102C is data related to a car body color that can be overcoated by an easily peelable paint. FIG. 3C indicates an example of the top coat color data 102C. As illustrated, the top coat color data 102C includes an identifier of a body color (second body color) that can be overcoated. The top coat color data 102C may include color sample data.

Each of the aforementioned data may be constructed by a program of a database management system (DBMS) executed by a processor to manage the data stored in the storage device. In this case, each data can be, for example, a relational database.

The communication unit 103 is a communication interface for connecting the contract server 100 to the network. The communication unit 103 includes, for example, a network interface board and a wireless communication interface for wireless communication.

The configuration shown in FIG. 2 is only an example, and all or part of the functions illustrated may be executed using a circuit specially designed. Further, the program may be stored or executed by a combination of a main memory and an auxiliary storage device other than the one illustrated.

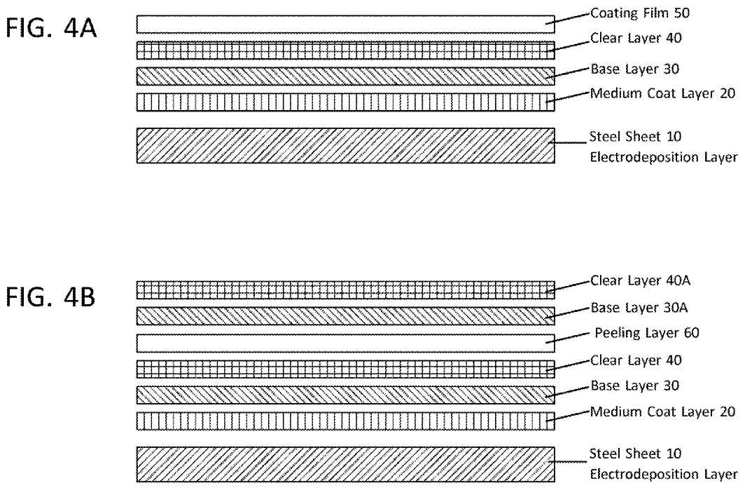

Here, an easily peelable paint will be described. FIG. 4A to 4B is a schematic cross-sectional view indicating a body member (for example, a steel sheet) included in a vehicle body and a coating film formed on the body member. As illustrated in the figure, the body member has a steel sheet 10 having a metal processing and having an electrodeposition layer formed thereon, an medium coat layer 20, a base layer 30, and a clear layer 40 formed sequentially on the electrodeposition layer.

The base layer 30 is a layer that serves as a base for painting. The base layer 30 may be a pearl layer, a mica layer, or a glass flake layer. Although this example shows an example in which the base layer 30 is a single layer, the base layer 30 may have two or more coating film. When the base layer 30 is two layers, the layers of the coating film are four layers together with the medium coat layer 20 and the clear layer 40. Further, the base layer 30 and the clear layer 40 may be provided on the clear layer 40 again.

A coating film 50 is formed on the outer surface of the body member. The coating film 50 is a layer of paint formed by coating an easily peelable paint, and has the property that it can be easily peeled off by applying a force compared to a normal coating film. The coating film 50 is formed by painting an easily peelable paint on the body member by, for example, a spraying method. Examples of the easily peelable paint include a paint made of xylene, ethylbenzene, an antioxidant, methylethyl ketone, a silica reactant, titanium oxide (nanoparticles), and an organic solvent.

In addition, when the coating of the vehicle is desired to have weather resistance, scratch resistance, and chipping resistance, a coating film 50 having each function can be applied.

Overcoating of the vehicle with an easily peelable paint can be performed at a predetermined base and before shipment of the vehicle. As a result, the body color of the vehicle can be easily changed (that is, the body color is changed from the first body color to the second body color). The same applies to the peeling of the coating film 50. By peeling off the coating film 50 at a predetermined base, the body color of the vehicle can be returned to the original one (that is, the second body color is changed to the first body color). Since the original paint is protected by the coating film 50, it is possible to obtain a used car whose body paint has not deteriorated.

The coating with the coating film 50 does not need to be performed on all of the body members. For example, it is not necessary to provide a coating film 50 for a portion that is not exposed to the outside during traveling, such as the inside of an opening such as a door.

In this example, a steel sheet is exemplified as a body member, but the body member may be a resin member. In this case, the medium coat layer 20 is a primer layer. Further, a clear layer may be provided on the coating film 50. In the example of FIG. 4A, the paint itself is easily peeled off, but a normal coating may be applied on a layer having easy peel off. For example, as shown in FIG. 4B, by using the same material as the coating film 50, an uncolored peeling layer 60 may be formed, and a base layer 30A and a clear layer 40A may be formed on the peeling layer 60. The base layer 30A is a layer of paint having a different color from the base layer 30. In such an embodiment, the layer of paint can be removed by peeling the peeling layer 60.

In this example, one color is exemplified as the first body color and the second body color, respectively, but the first body color and the second body color may be composed of a plurality of colors. For example, a plurality of colors arranged according to a predetermined pattern may be a first body color or a second body color. Further, the overcoating with the second body color may be performed on at least a part of the painting with the first body color. That is, the overcoating with the second body color does not have to cover all of the painting with the first body color. For example, when the first body color is black, a vehicle having two-tone colors of black and blue can be obtained by applying a blue overcoat to a part thereof.

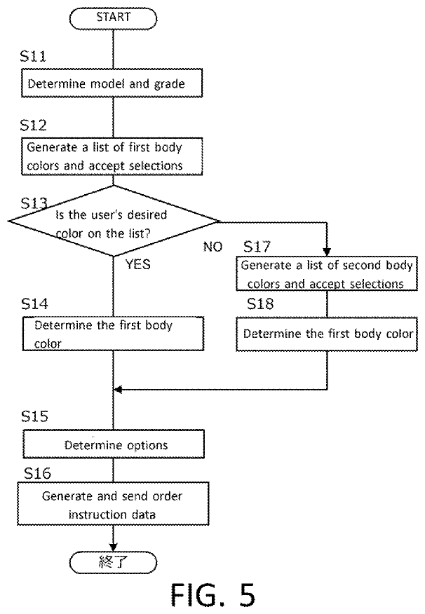

Returning to the description of the contract server 100. FIG. 5 is a flowchart showing a process executed by the contract server 100. The process shown in FIG. 5 is started at the timing when the user logs in to the contract server 100, for example. At the timing of starting the illustrated process, it is assumed that the contract server 100 has completed the identification of the user.

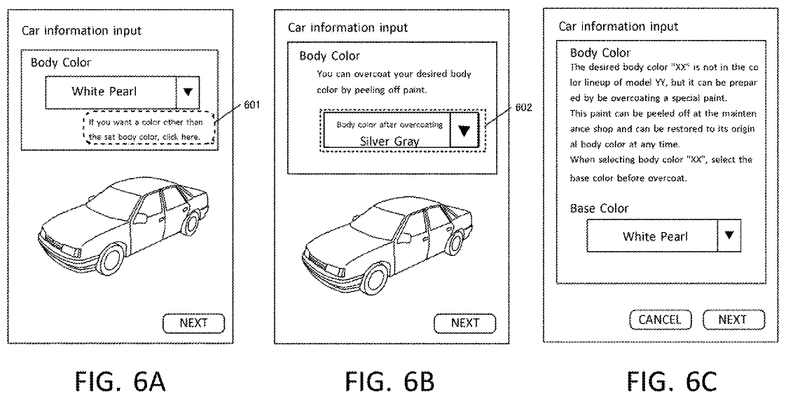

The processes of steps S11 to S15 are executed by the specification determination unit 1011. In step S11, the model and grade of the vehicle are determined. In the present step, the user is made to select the model and grade desired by the user from a combination of a plurality of preset models and grades. In the following description, the combination of the determined model and grade is referred to as a target vehicle. In step S12, a list of first body colors set for the target vehicle is generated and presented to the user. The list of first body colors set for the target vehicle can be generated based on the basic color data 102B. At this time, the color sample may be presented at the same time. FIG. 6A is an example of a screen presented to the user via the user terminal 200.

In step S13, it determined whether or not the body color of the vehicle desired by the user is in the first body color list. For example, when a specific body color of the vehicle is selected from the list of the first body color, this step is a positive determination, and the process transitions to step S14. In step S14, the selected body color of the vehicle is determined as the first body color.

On the other hand, when the user states that there is no desired body color of the vehicle in the first body color list (for example, when the link 601 indicated by the dotted line in the figure is clicked), the process transitions to step S17. In step S17, a list of colors (second body colors) that can be overcoated with an easily peelable paint is generated and output. In addition, the selection of the second body color is accepted from the list. FIG. 6B is an example of a screen including a list of second body colors. The list of the second body color may be presented using a list box (reference numeral 602) or the like, or may be presented using a color picker or the like.

When the second body color is selected, the first body color, that is, the body color of the vehicle before the overcoating, is determined in step S18. The first body color may be determined by the contract server 100 based on a predetermined standard. For a predetermined criterion, for example, the following can be adopted.
(1) Of the body colors of the plurality of vehicles, the body color of the vehicle whose evaluation value is expected to be the highest at a predetermined point in the future is determined as the first body color.
(2) Determine one of the body colors of the vehicle whose evaluation value is expected to be higher than the predetermined value at a predetermined point in the future as the first body color.
   Therefore, the contract server 100 may store a database or the like for acquiring the evaluation value for each body color of the vehicle at a predetermined point in the future. In addition, the contract server 100 may appropriately determine predetermined points in the future.

The predetermined value can be a value based on the new car price of the corresponding vehicle model. For example, the first body color can be a color whose evaluation value after three years is higher than 65% of the new car price. In general, the color of a vehicle with a high valuation is determined by its popularity in the used car market. For example, the body color including the pearl layer and the pearl mica layer is more popular than the body color of other vehicles, and the evaluation value tends to be high. The first body color may be selected as long as the body color of the vehicle has a higher evaluation value than the second body color.

In the above example, the contract server 100 determines the first body color, but the first body color may be selected by the user. FIG. 6C is an example of a screen for selecting a first body color. At this time, the contract server 100 may present, as reference information, the expected evaluation amount of the vehicle after the predetermined period has elapsed for each body color of the vehicle.

The contract server 100 may output a message recommending the use of an easily peelable paint in the processing of step S17 or S18. In addition, a message explaining the advantages and disadvantages of applying the overcoating may be output.

By the processing up to this point, the body color of the vehicle and the painting method thereof are determined. In step S15, an option or the like attached to the vehicle is selected. In this step, for example, options provided by a manufacturer such as safety equipment and options provided by a dealer such as an in-vehicle terminal are accepted.

When the specification of the vehicle is determined, specification data is generated and stored according to the determined specification.

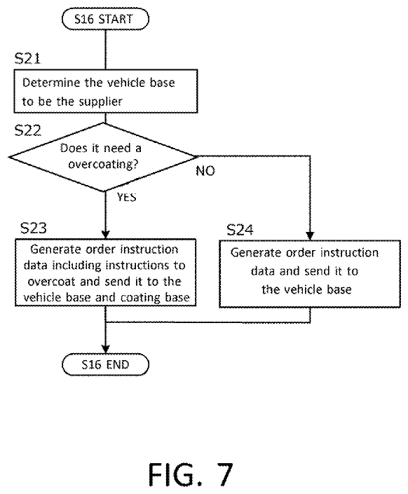

In step S16, the ordering unit 1012 generates order instruction data based on the generated specification data and transmits the order to the vehicle base for receiving an order. FIG. 7 is a flowchart of a process executed by the ordering unit 1012 in step S16.

First, in step S21, the ordering unit 1012 determines a vehicle base for transmitting an order for the vehicle. In this step, for example, the presence or absence of an inventory of a vehicle having a specification indicated by the specification data is confirmed, and it is determined whether to deliver a vehicle in inventory or to produce a new vehicle, and then a vehicle base for ordering an order for the vehicle is determined.

Next, in step S22, the ordering unit 1012 determines whether or not a overcoating is necessary. When an overcoating is required, for example, when both the first body color and the second body color are specified in the specification data.

When only the first body color is specified for the target vehicle, the ordering unit 1012 generates order instruction data and transmits the order instruction data to the vehicle base that provides the vehicle (step S24). When both the first body color and the second body color are specified for the target vehicle, the ordering unit 1012 generates order instruction data including a painting instruction, and transmits the order instruction data to the vehicle base for providing the vehicle and to the painting base for applying a overcoating to the vehicle (step S23). The ordering instruction data includes specifications of the vehicle (including the first body color and the second body color), designation of the coating base to perform the overcoating, and the like.

The coating base for performing the overcoating may be, for example, a dealer, an inspection center, a maintenance shop, or the like. The vehicle base and the coating base may be the same.

In step S16, the delivery date of the vehicle in the case of overcoating the determined second first body color to the vehicle having the determined first body color may be determined. For example, the ordering unit 1012 may determine the delivery date of the requested vehicle and present it to the user. At the timing when the transmission of the order instruction data is completed, the contract server 100 may notify the user that the order for the vehicle has been completed.

The vehicle base that has received the order instruction data to carry out the overcoating prepares (or produces) a vehicle having a first body color, performs the overcoating with a second body color as necessary, and delivers the vehicle to the user. Overcoating with the second body color can be performed at the designated coating base. If the vehicle base for preparing (or producing) the vehicle is different from the coating base, the vehicle may be forwarded. The vehicle base that receives the order instruction data to the effect that the overcoating will not be performed prepares (or produces) vehicles with the first body color and delivers them to the user.

As described above, in the vehicle ordering system according to the first embodiment, whether or not to use an easily peelable paint is proposed to the user based on whether or not the body color of the vehicle desired by the user is the body color of the vehicle set as the base color of the target vehicle. According to such a configuration, it is possible to provide a vehicle having the body color of the vehicle desired by the user.

Since the easily peelable paint has a useful life, when the vehicle is overcoated with the easily peelable paint, it is preferable to provide guidance to the user regarding the useful life of the paint. For example, the contract server 100 may transmit information on the useful life of the paint to the user terminal 200. Further, if the vehicle is scheduled to be used beyond the service life, it may be indicated that it is necessary to peel off the topcoat on the way. Further, if the vehicle is scheduled to be used beyond the service life, it may be suggested to the user not to use the easily peelable paint.

### Modification of the First Embodiment

In the first embodiment, a list of base colors (first body colors of the vehicle) set for the target vehicle is provided, and when the desired body color of the vehicle is not present in the list of base colors, a list of second body colors of the vehicle is provided. However, the first body color of the vehicle and the second body color of the vehicle may be provided at the same time.

In this modification, for example, in step S12, a graphical user interface including a color chart (color picker) including a first body color of all vehicles and a second body color of all vehicles may be generated to accept a color selection from the user. Further, in step S13, it is determined whether the selected color is a color included in the first body color of the vehicle or a color included in the second body color of the vehicle, and the process may be branched based on the determination result. For example, if the selected color is a color included in the first body color of the vehicle, the transition may be made to step S14. Further, when the selected color is a color included in the second body color of the vehicle, the transition may be made to step S17. In this case, in step S18, the first vehicle body color may be selected using the same tool.

In general, the color variation of the second body color of the vehicle is larger than the color variation of the first body color of the vehicle. Therefore, a color close to the color present in the list of base colors may be selected as the second body color of the vehicle. Therefore, in such a case, the user may be notified that a color similar to the selected color exists in the list of base colors (in other words, it is not necessary to use an easily peelable paint). Specifically, when the color selected as the second body color of the vehicle has a degree of similarity with the color included in the first body color of the vehicle by a predetermined value or more, a message notifying that a similar color exists in the list of base colors may be output. The degree of color similarity may be determined by the proximity of numerical values in a predetermined system.

### Modification

The above embodiment is only an example, and the present disclosure can be appropriately modified and implemented within the scope of not departing from the gist. For example, the processes and means described in the present disclosure can be freely combined as long as there is no technical contradiction.

Further, in the description of the embodiment, a form in which a vehicle is sold to a user is exemplified, but the information processing apparatus according to the present disclosure can also be applied to a form other than sales, such as lending.

Further, the processing described as being performed by one device may be shared and executed by a plurality of devices. Alternatively, the processing described as being performed by different devices may be performed by one device. In the computer system, it is possible to flexibly change what kind of hardware configuration (server configuration) each function is realized.

The present disclosure can also be realized by supplying a computer program implementing the functions described in the above embodiment to a computer, and one or more processors included in the computer read out and execute the program. Such computer programs may be provided to a computer by a non-transitory computer-readable storage medium connectable to a system bus of the computer, or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. An information processing apparatus for determining a specification of a vehicle ordered by a user, comprising a controller unit configured to execute:
receiving designation of a body color of the vehicle from the user; and
proposing to the user to overcoat the vehicle with a second body color by an easily peelable paint after ordering the vehicle having any of a plurality of first body colors when the second body color that is not included in the plurality of first body colors set as a base color of the vehicle is designated by the user.

2. The information processing apparatus according to claim 1, wherein the controller unit presents a list of the plurality of first body colors and the plurality of second body colors that are colors that can be overcoated with the easily peelable paint.

3. The information processing apparatus according to claim 1, wherein the controller unit selectively presents a list of the plurality of first body colors and a list of the plurality of second body colors that are colors that can be overcoated with the easily peelable paint.

4. The information processing apparatus according to claim 2, wherein the controller unit proposes to the user not to use the easily peelable paint when a body color that is a body color included in the plurality of second body colors and whose degree of similarity with any of the plurality of first body colors is a predetermined value or more is specified.
